(19) United States
(12) Patent Application Publication
(10) Pub. No.: US 2007/0057614 A1
(43) Pub. Date: Mar. 15, 2007

(54) Stabilizing device, fluorescent lamp comprising such a device, and method of reinforcing a fluorescent lamp

(76) Inventors: Zenon Stanislaw Koplin, Pila (PL); Erik Adrianus Andreas De Jong, Roosendaal (NL)

Correspondence Address: PHILIPS INTELLECTUAL PROPERTY & STANDARDS, P.O. BOX 3001, BRIARCLIFF MANOR, NY, 10510, US

(21) Appl. No.: 10/561,470

(22) PCT Filed: Jun. 22, 2004
(86) PCT No.: PCT/IB04/50969

§ 371 Date: Dec. 20, 2005

(30) Foreign Application Priority Data
Jun. 25, 2003 (EP) 03101874.0

(51) Int. Cl. H01J 5/48

(52) U.S. Cl. 313/318.01

(57) ABSTRACT

The invention provides a stabilizing device (1) for reinforcing a burner part of a fluorescent lamp comprising a number of glass tubes connected by at least one bridge part characterized in that the stabilizing device comprises at least one plastic holder provided with at least two separate contact surfaces (2, 3) shaped to fit the burner part of the fluorescent lamp in at least two separate locations. The invention also provides a fluorescent lamp comprising such a stabilizing device and a method of reinforcing a burner part of a fluorescent lamp.

The present invention relates to a stabilizing device for reinforcing a burner part of a fluorescent lamp comprising a number of glass tubes connected by at least one bridge part so as to form a discharge path through the tubes between two electrodes which are each provided in one of the tubes. The invention further relates to a fluorescent lamp with a burner part comprising a number of glass tubes connected by at least one bridge part so as to form a discharge path through the tubes between two electrodes which are each provided in one of the tubes and a method of reinforcing the burner part of such a fluorescent lamp.

Fluorescent lamps comprising a number of glass tubes connected by bridges are generally known and sold as, for example, PL and SL lamps in the market. Normally, but not exclusively, these lamps comprise an even number (e.g. 2, 4, 6, or 8) of substantially parallel glass tubes (legs) connected by bridge portions. The glass tube assembly; normally including two electrodes, is assembled with a base comprising electrode terminals for supplying electric power to the electrodes. To make these fluorescent lamps mechanically less vulnerable, it is a know technique to apply silicone dots in between the legs. However, these silicone dots do not improve the strength sufficiently and the strength provided by the silicon dots is not fully controlled. Furthermore, the application of silicon dots is not desired because of esthetical disadvantages.

The object of the invention is to provide means for improving the strength of fluorescent lamps for which the above-mentioned drawbacks do not arise. The object of the invention is also to provide an improved fluorescent lamp and an easy method for production of such an improved fluorescent lamp.

This object is achieved in accordance with the invention with a stabilizing device for reinforcing a burner part of a fluorescent lamp comprising a number of glass tubes connected by at least one bridge part so as to form a discharge path through the tubes between two electrodes which are each provided in one on the tubes, characterized in that the stabilizing device comprises at least one plastic holder provided with at least two separate contact surfaces shaped to fit the burner part of the fluorescent lamp in at least two separate locations. Due to the stabilizing device the relative position of the glass tubes is supported. This effect is especially desired when a load is applied to the burner part (e.g. during transport or during insertion or removal of the fluorescent lamp in/from a socket). This effect is even more appreciated as longer lamps (longer burner lengths) are coming into use. The use of a plastic holder achieves that the process of stabilizing the legs can be controlled as the dimensions of the stabilizing device are fully controllable. The esthetical effect of the stabilizing element is also controllable; e.g. color, transparency, and shape are dependent on the plastic holder. Preferably, at least one of the contact surfaces forms a housing for receiving a burner part, the housing having an aperture to give the burner part access to the housing, which opening has a width that is smaller than a maximum clearance provided in the housing. Such a housing normally has a three-dimensional shape to provide a dimensionally stable grip on the burner part. The advantage of a form fit coupling is that the connection can be provided without exerting a continuous pre-load on the burner part thus reducing the risk of damage to the burner part caused by the stabilizing device. In another embodiment,the stabilizing device comprises at least one bumper part that projects from the stabilizing part so that, when installed on the burner part, the bumper part will absorb loads that could damage the burner part of the lamp.

The stabilizing device may be made of a flexible material, and the contact surface forms a housing to snap-fit on a burner part. An easy and cheap solution is the use of an injection-molded plastic part, e.g. molded from polybutylene-terephthalate. However, the stabilizing device may alternatively be made from a rigid material not providing the option of a snap-fit but designed to be coupled by manipulation with the stabilizing device (e.g. rotation or linear placement in line with the axis of the glass tubes).

An additional functionality can be provided to a fluorescent lamp by providing the stabilizing device also with a light-influencing device, such as e.g. a mirror, a filter, a transparent material, and/or a lens. For example, providing a stabilizing device with a mirror enables the construction of an upward or downward reflecting fluorescent lamp without the need of mirrors in the fixture (luminaire). This embodiment also enables the provision of a transparent masking (covering) to prevent a direct view of the fluorescent lamp. The coupling of a light-influencing device may easily be realized in combination with the assembly of the lamp and the stabilizing device, so it does not require an extra handling. Furthermore, the coupling of the fluorescent lamp and the light-influencing device can be achieved without damage to the lamp. Instead of or in combination with light-influencing means, the stabilizing device may also be combined with means for improving the ignition of the lamp or for lowering the ignition voltage, which is favorable for the ballast.

The present invention also provides a fluorescent lamp with a burner part comprising a number of glass tubes connected by at least one bridge part so as to form a discharge path through the tubes between two electrodes which are each provided in one of the tubes, characterized in that the fluorescent lamp also comprises a stabilizing device as disclosed above, the stabilizing device being connected to the burner part of the fluorescent lamp in a dimensionally stable manner, thus stabilizing the burner part. Preferably, the stabilizing device is connected to the burner part of the fluorescent lamp in a dimensionally stable manner without exerting a pre-load on the burner part; i.e. not exerting a pre-load in normal circumstances of use. Such normal circumstances are defined as circumstances in which the burner part is not mechanically loaded. The stabilizing device is preferably located on the burner part opposed to the side of the burner part connected to a lamp base as its stabilizing function is best performed at this relatively weak location of-the burner part. It is also possible to provide a fluorescent lamp with more than one stabilizing device, as well as to provide the fluorescent lamp with a stabilizing device carrying a light-influencing device. For further advantages of these lamps according the present invention reference is made to the above-identified advantages in relation to the stabilizing device according the invention.

Furthermore, the invention also provides a method of reinforcing a burner part of a fluorescent lamp comprising a number of glass tubes connected by respective bridge parts so as to form a discharge path through the tubes between two electrodes which are each provided in one of the tubes, characterized in that, after the burner part of the fluorescent lamp has been manufactured by the connection of a number of glass tubes to at least one bridge part, said the bridge part is provided with a stabilizing device as disclosed above. Preferably, the stabilizing device is connected to the burner part of the fluorescent lamp by a snap connection. Such a method is no hindrance to the production method of fluorescent lamps used according the prior art. The stabilizing device (or devices) can be coupled to the fluorescent lamp after the well-known manufacture of the lamps has been completed. If so desired, the stabilizing device can also be removed from a fluorescent lamp, for example after a period with high risk (e.g. transport) has ended. The removed stabilizing device may be re-used later for stabilizing the same or another florescent lamp.

The invention will now be described with reference to the non-limitative embodiments shown in the accompanying drawing, in which:

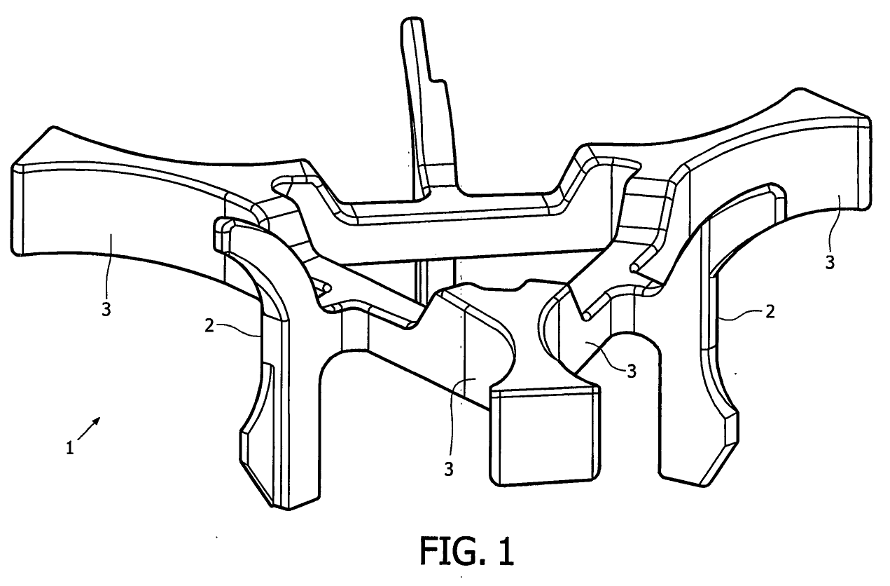

FIG. 1 is a perspective view of a stabilizing device according the present invention;

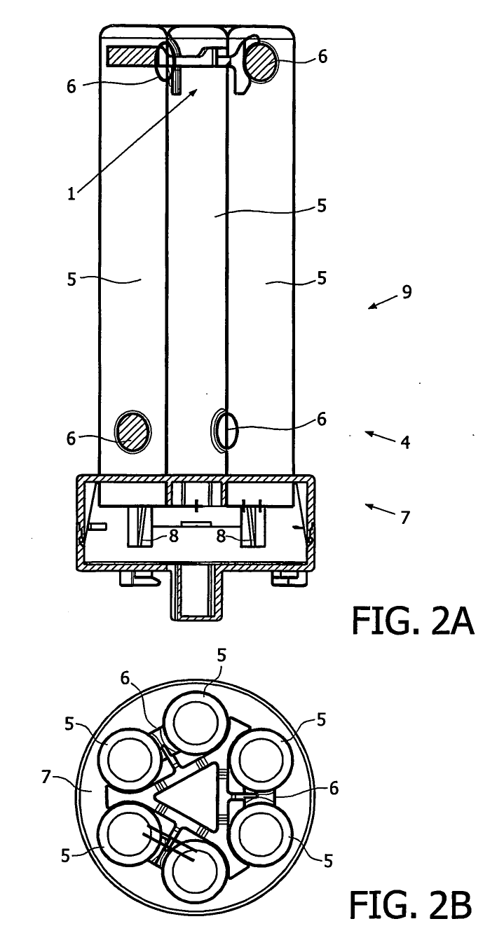

FIG. 2A is a longitudinal sectional view of a fluorescent lamp comprising the stabilizing device shown in FIG. 1;

FIG. 2B is a horizontal sectional view of the lamp shown in FIG. 2A;

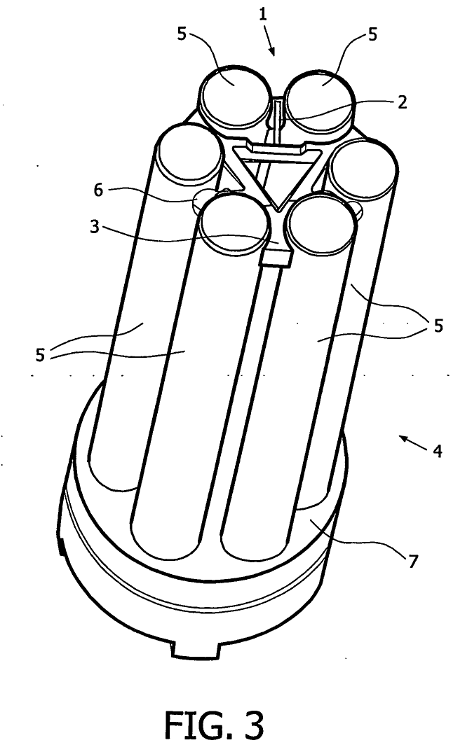

FIG. 3 is a perspective view of the lamp shown in FIGS. 2A and 2B;

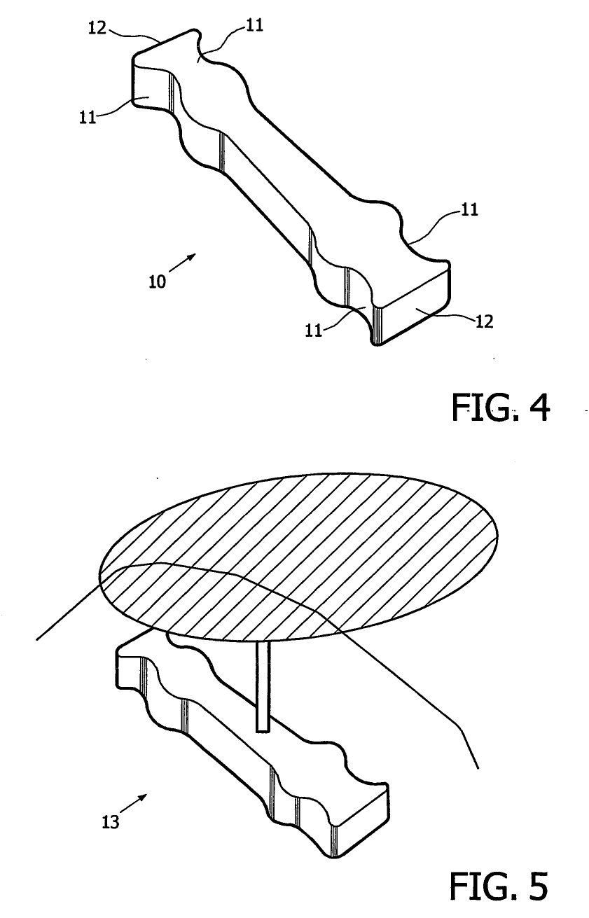

FIG. 4 is a perspective view of a second, alternative embodiment of a stabilizing device according the present invention; and

FIG. 5 is a perspective view of a third, alternative embodiment of a stabilizing device according the present invention.

FIG. 1 shows a stabilizing device 1 comprising two differently shaped types of contact surfaces 2 and 3. The first type of contact surfaces 2 is provided in triplicate and is designed to fit the bridge parts of fluorescent lamps; this will be shown in FIGS. 2 and 3. The device 1 also has six second-type contact surfaces 3 designed to fit the glass tubes of fluorescent lamps; this will also be shown in FIGS. 2 and 3.

FIGS. 2A and 2B show the device 1 in an assembled position with a fluorescent lamp 4. The fluorescent lamp 4 has parallel glass tubes 5 that are coupled to bridge parts 6 to form a discharge path through the tubes 5. On one side the tubes 5 are housed in a base 7 comprising electrode terminals 8 for supplying electric power to the electrodes (not shown) in the tubes 5. The device 1 contacts both the bridge parts 6 and the tubes 5, thus stabilizing the assembly of the tubes 5, which are also indicated as a burner part 9. The same device 1 and the fluorescent lamp 4 are also shown in FIG. 3. In this FIG. 3 it can be recognized that the first-type contact surfaces 2 contact the bridge parts 6 of the fluorescent lamp 4 while the second-type contact surfaces 3 contact the tubes 5.

FIG. 4 shows a stabilizing device 10 provided with two pairs of contact surfaces 11, each pair of contact surfaces 11 to be placed in between mutually opposed glass tubes of a fluorescent lamp. The stabilizing device 10 has two mutually opposed protruding end parts 12 that can function as bumpers when the stabilizing device is coupled to a lamp.

Finally, FIG. 5 shows a stabilizing device 13 that corresponds partially to the stabilizing device 10 as shown in FIG. 4 except for a shielding element 14 that is additionally provided.

1. Stabilizing device (1, 10, 13) for reinforcing a burner part (9) of a fluorescent lamp (4) comprising a number of glass tubes (5) connected by at least one bridge part (6) so as to form a discharge path through the tubes (5) between two electrodes which are each provided in one of the tubes (5), characterized in that the stabilizing device (1, 10, 13) comprises at least one plastic holder provided with at least two separate contact surfaces (2, 3, 11) shaped to fit the burner part (9) of the fluorescent lamp (4) in at least two separate locations.

2. Stabilizing device (1, 10, 13) according to claim 1, characterized in that at least one of the contact surfaces (2, 3, 11) forms a housing for receiving a burner part (9), the housing having an aperture to give the burner part (9) access to the housing, which opening has a width that is smaller than a maximum clearance provided in the housing.

3. Stabilizing device (1, 10, 13) according to claim 1, characterized in that the stabilizing device (1, 10, 13) is made of a flexible material and the contact surface (2, 3, 11) forms a housing to snap-fit on a burner part (9).

4. Stabilizing device (1, 10, 13) according to claim 1, characterized in that the stabilizing device (1, 10, 13) comprises at least one bumper part (12) that projects from the stabilizing device (1, 10, 13).

5. Stabilizing device (1, 10, 13) according to claim 1, characterized in that the stabilizing device (1, 10, 13) is an injection-molded plastic part.

6. Stabilizing device (1, 10, 13) according to claim 1, characterized in that the stabilizing device (1, 10, 13) also comprises a light-influencing device (14).

7. Fluorescent lamp (4) with a burner part (9) comprising a number of glass tubes (5) connected by at least one bridge part (6) so as to form a discharge path through the tubes (5) between two electrodes which are each provided in one of the tubes (5), characterized in that the fluorescent lamp (4) also comprises a stabilizing device (1, 10, 13) according claim 1, the stabilizing device (1, 10, 13) being connected to the burner part (9) of the fluorescent lamp (4) in a dimensionally stable manner, thus stabilizing the burner part (9).

8. Fluorescent lamp (4) according to claim 7, characterized in that the stabilizing device (1, 10, 13) is connected to the burner part (9) of the fluorescent lamp (4) in a dimensionally stable manner without exerting a pre-load on the burner part (9).

9. Fluorescent lamp (4) according to claim 7, characterized in that the stabilizing device (1, 10, 13) is located on the burner part (9) opposite to the side of the burner part (9) connected to a lamp base (7).

10. Fluorescent lamp (4) according to claim 7, characterized in that the fluorescent lamp (4) is provided with at least two stabilizing devices (1, 10, 13) for reinforcing a burner part (9) of a fluorescent lamp (4) comprising a number of glass tubes (5) connected by at least one bridge part (6) so as to form a discharge path through the tubes (5) between two electrodes which are each provided in one of the tubes (5), characterized in that the stabilizing device (1, 10, 13) comprises at least one plastic holder provided with at least two separate contact surfaces (2, 3, 11) shaped to fit the burner part (9) of the fluorescent lamp (4) in at least two separate locations.

11. Fluorescent lamp (4) according to claim 7, characterized in that the fluorescent lamp (4) is provided with a stabilizing device (1, 10, 13) carrying a light-influencing device (14).

12. Method of reinforcing a burner part (9) of a fluorescent lamp (4) comprising a number of glass tubes (5) connected by respective bridge parts (6) so as to form a discharge path through the tubes (5) between two electrodes which are each provided in one of the tubes (5), characterized in that, after the burner part (9) of the fluorescent lamp (4) has been manufactured through connection of a number of glass tubes (5) to at least one bridge part (6), said bridge part (6) is provided with a stabilizing device (1, 10, 13) according to claim 1.

13. Method according to claim 12, characterized in that the stabilizing device (1, 10, 13) is connected to the burner part (9) of the fluorescent lamp (4) by a snap connection.
